(19) United States
(12) Patent Application Publication
(10) Pub. No.: US 2024/0152746 A1
(43) Pub. Date: May 9, 2024

(54) NETWORK-BASED CONVERSATION CONTENT MODIFICATION

(71) Applicant: AT&T Intellectual Property I, L.P., Atlanta, GA (US)

(72) Inventors: Aritra Guha, Edison, NJ (US); Jean-Francois Paiement, Palm Desert, CA (US); Eric Zavesky, Austin, TX (US)

(21) Appl. No.: 17/982,511

(22) Filed: Nov. 7, 2022

(51) Int. Cl. G06N 3/08

(52) U.S. Cl. CPC G06N 3/08

(57) ABSTRACT

A processing system including at least one processor may obtain at least a first objective associated with a demeanor of at least a first participant for a conversation and may activate at least one machine learning model associated with the at least the first objective. The processing system may then apply a conversation content of the at least the first participant as at least a first input to the at least one machine learning model and perform at least one action in accordance with an output of the at least one machine learning model.

The present disclosure relates generally to network-based communication sessions, and more particularly to methods, computer-readable media, and apparatuses for performing at least one action in accordance with an output of at least one machine learning model that is activated based on at least a first objective associated with a demeanor of at least a first participant of a network-based conversation.

### BRIEF DESCRIPTION OF THE DRAWINGS

The teachings of the present disclosure can be readily understood by considering the following detailed description in conjunction with the accompanying drawings, in which:

FIG. 1 illustrates an example network related to the present disclosure;

FIG. 2 illustrates a flowchart of an example method for performing at least one action in accordance with an output of at least one machine learning model that is activated based on at least a first objective associated with a demeanor of at least a first participant of a network-based conversation; and

FIG. 3 illustrates a high level block diagram of a computing device specifically programmed to perform the steps, functions, blocks and/or operations described herein.

To facilitate understanding, identical reference numerals have been used, where possible, to designate identical elements that are common to the figures.

### DETAILED DESCRIPTION

In one example, the present disclosure describes a method, computer-readable medium, and apparatus for performing at least one action in accordance with an output of at least one machine learning model that is activated based on at least a first objective associated with a demeanor of at least a first participant of a network-based conversation. For instance, a processing system including at least one processor may obtain at least a first objective associated with a demeanor of at least a first participant for a conversation and may activate at least one machine learning model associated with the at least the first objective. The processing system may then apply a conversation content of the at least the first participant as at least a first input to the at least one machine learning model and perform at least one action in accordance with an output of the at least one machine learning model.

Various communication modalities exist, such as face-to-face speech, as well as network-based voice, text, or video conversations. However, individual emotional understanding and communication may be difficult for some individuals, which may be made even more challenging by certain communication modalities. For instance, some users may have difficulty in reading the emotions of others, other users may have difficulty in conveying their own emotions properly, and so forth. Examples of the present disclosure provide for network-based enhancement of conversation semantics (e.g., emotional state/demeanor as well as meaning). In one example, one or more machine learning (ML) or artificial intelligence (AI) models are trained and implemented to enable such functionality.

In one example, in advance of a conversation, one or both participants (or more than two participants for a group conversation) may specify one or more intended conversational goals. In one example, one or more of the participants may also provide an anticipated context for the upcoming discussion, which can include one or more topic(s), an expectation of whether the conversation will be “contentious,” “friendly,” or the like. The context may also include the intended communication modality, or modalities, e.g., a voice call, a text-based communication session, voice-to-text, video call, a virtual reality or augmented reality call, and so forth. In one example, the present disclosure may load user profiles of one or more of the participants (e.g., preferred language(s), language(s) in which a participant is knowledgeable, disposition(s) of the participant, relationships of the participant to others, markers of past conversations with others (e.g., “contentious,” “friendly,” etc., and so forth)). In one example, the context may also include the language(s) of one or more of the participants. For instance, the present disclosure may comprise a network-based processing system that may include a language translation component. In one example, the present disclosure may baseline a current emotional state, or demeanor of a participant (or demeanors of multiple participants). In one example, this may comprise one or more machine learning or artificial intelligence models that may be configured to detect particular demeanors, or categories of demeanors/emotional states based upon one or more types of inputs, which may include image data (e.g., still images or video), biometric data (e.g., breathing rate, heart rate, etc.), and so forth. In one example, demeanor may also be determined from the conversational content (e.g., text/speech semantics/meaning and/or voice tone, pitch, etc.). In one example, the present disclosure may encode demeanor and context factors in a state or machine learning model representation (e.g., numerically or the like).

In one example, the present disclosure may track the interactions within a conversation for one or multiple participants. For illustrative purposes, the following examples are primarily described in connection with a goal of a single participant. However, it should be understood that in other, further, and different examples, the present disclosure may facilitate goals of two or more participants. Example goals, or objectives, may include an objective of a first participant to align conversation content of first participant with the emotional state/demeanor of the first participant during the conversation, an objective of the at least the first participant to convey a selected demeanor to at least the second participant, e.g., calm, angry, upset, etc., an objective of the first participant to reach an agreement with at least a second participant, an objective of the first participant to avoid upsetting at least a second participant, and so forth.

During the conversation, all communications (conversation content) may be conveyed from user endpoint devices via a processing system of the present disclosure. In one example, the processing system may analyze the conversation content for conformance to the objective(s), such as to align the conversation content to the demeanor of the first participant. For instance, the processing system may apply the conversation content to one or more machine learning models for detecting a demeanor. In one example, the processing system may also obtain biometric, video, or other data to apply to one or more other machine learning models for detecting a demeanor, and may determine whether the demeanors determined in accordance with these different sources are the same (e.g., to verify consensus among the different models). In another example, the processing system may directly inquire of the participant's demeanor. In either case, in one example, the processing system may update the current state of the first participant's demeanor on an ongoing basis during the conversation. In one example, the processing system may also gather information indicative of another participant's demeanor/emotional state (e.g., angry, happy, brooding, sad, etc.), such as for an example in which the objective is to not upset the other participant or to reach an agreement with the other participant (e.g., where the other participant has specifically consented to provide or allow such information to be gathered and utilized for this purpose).

In another example, the processing system may apply the conversation content to one or more machine learning models that may adjust the conversation content to align to an objective, such as changing text/semantic content to be less confrontational, more confrontational, etc. For instance, the conversation content (e.g., textual content) may be applied to a transformer, or encoder-decoder neural network that is configured to output generated text. Alternatively, or in addition, the adjusting may include changing the tone, pitch, or other aspects of a voice of the first participant. For instance, a speech model trained from the voice of the first participant may be used to output generated speech in accordance with an original or modified textual representation (e.g., generated text) of the conversation content. In one example, the processing system may accept a communication (e.g., an utterance) but will suppress from immediately sharing of this communication with another participant (e.g., applying a delay).

In one example, the present disclosure may represent a participant's demeanor via emoticon, visual indicator, background sound, vibration, etc. In one example, a notification may be provided to a participant when the conversation content of the participant does not align with a demeanor of the participant that is determined via other sources (e.g., biometric and/or video data). In one example, the present disclosure may send time stamped alerts to one or multiple participants (e.g., of the participants' own demeanors and/or of others, or of disconnects between conversation content and demeanor(s) determined via other inputs).

In one example, the present disclosure may provide conversational suggestions for delayed or accelerated introduction of topics. In one example, a desire to introduce one or more specific topics may be part of an objective, or objectives. In addition, in one example, the present disclosure may suggest a recasting of a topic, e.g., based on the demeanor(s) of one or more participants. In one example, the present disclosure may continue to analyze conversation content for a duration of the conversation. However, in one example, the present disclosure may entertain requests to disengage monitoring (from one or multiple participants). In one example, the present disclosure may update user profiles of one or multiple participants based on the conversation (e.g., whether the objective(s) was/were reached, the dispositions of one or multiple participants during the conversation (e.g., if the conversation was contentious, a profile record indicating a relationship between theses participants is more likely to be labeled “contentious”)). In one example, the present disclosure may also identify which parts of conversations were more successful (e.g., those associated with the achieving of an objective or which cause, or were associated with positive demeanors in one or multiple participants) or less successful (e.g., causing negative demeanors in one or multiple participants).

Thus, examples of the present disclosure make communication content adaptive to individual context, assisting engaged parties to achieve stated objectives for the conversation. Examples of the present disclosure may be useful for individuals specifically dealing with trauma and who may benefit from avoidance or minimization of certain dispositions or classes of dispositions of other participants. For instance, this may be facilitated by transformation of communication content from other participants as described herein. In one example, the present disclosure may also be deployed in a connection with a user learning a new language. For instance, this may include guiding responses in the presence of different (individual) accents, reducing initial barriers in general conversation that may arise in a multi-cultured environment (such as in company offices). Examples of the present disclosure may also assist users in matching real-world understanding and assessment of emotional state to contextual requirements (e.g., for retail, remote educational, or support roles). Similarly, the present disclosure may be deployed for speech therapy (or for another participant in the conversation in the presence of speech-impairments), for assisting two participants who are both non-native speakers of a language in which the participants are conversing, and so forth. In one example, the present disclosure may include non-real time training, e.g., as a voice assistant for conversation practice, which may also be used as a training data set for a conversation to be had, e.g., learning where emotional states may be triggered by certain topics, or the like.

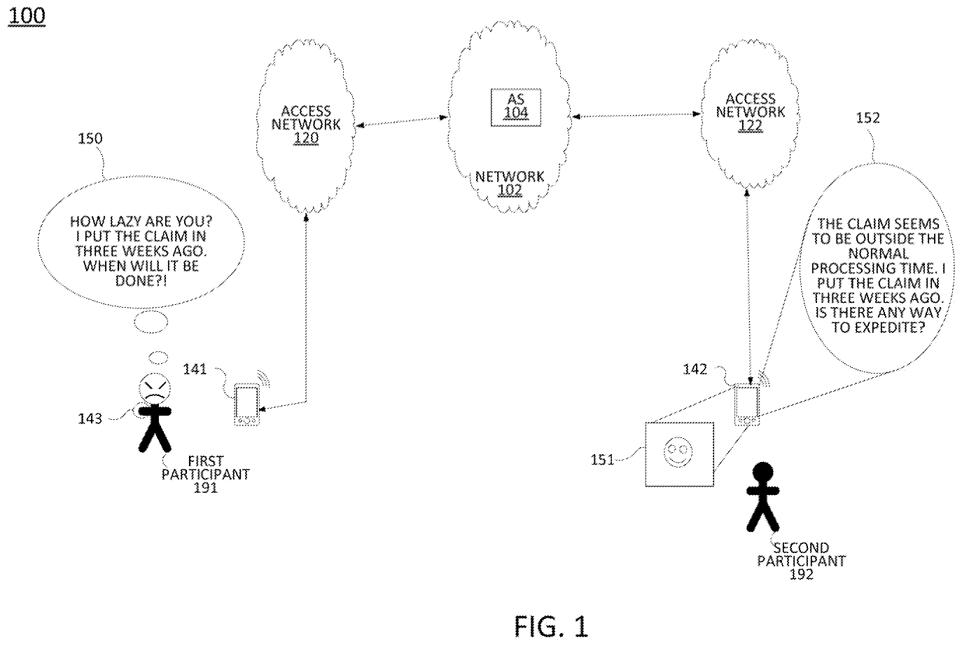

Thus, the present disclosure may comprise a processing system for voice, video, or XR conversations that can capture and modify conversation content based on the participant's (or participants') emotional state(s), or demeanor(s) as determined via the conversation content itself and/or in accordance with one or more other inputs, such as biometric data (or video data, where the conversation is a video-based conversation). In one example, the present disclosure may be extended to account for more base-level biometrics (e.g., bodily pain, measured stress, fatigue, etc.). For instance, a participant objective may include an objective to convey a specified demeanor of a first participant to other participants, an objective to align a demeanor exhibited in conversation content (e.g., words, tone, etc.) to a demeanor of a participant determined in another way, such as via biometric data, an objective to reach an agreement, an objective to not upset another participant, an objective to discuss a particular topic, and so forth. In one example, the present disclosure may be integrated between two parties to provide a neutral perception space, e.g., where both parties can speak their minds but have a projection to neutral tone and language for better communication. Alternatively, the projection may be from a more neutral tone and language to a projected space that better aligns with a participant's true emotional state/demeanor. These and other aspects of the present disclosure are described in greater detail below in connection with the examples of FIGS. 1-3.

To further aid in understanding the present disclosure, FIG. 1 illustrates an example system 100 in which examples of the present disclosure may operate. The system 100 may include any one or more types of communication networks, such as a traditional circuit switched network (e.g., a public switched telephone network (PSTN)) or a packet network such as an Internet Protocol (IP) network (e.g., an IP Multimedia Subsystem (IMS) network), an asynchronous transfer mode (ATM) network, a wireless network, a cellular network (e.g., in accordance with 3G, 4G/long term evolution (LTE), 5G, etc.), and the like related to the current disclosure. It should be noted that an IP network is broadly defined as a network that uses Internet Protocol to exchange data packets. Additional example IP networks include Voice over IP (VoIP) networks, Service over IP (SoIP) networks, and the like.

In one example, the system 100 may comprise a network 102, e.g., a telecommunication service provider network, a core network, an enterprise network comprising infrastructure for computing and communications services of a business, an educational institution, a governmental service, or other enterprises. The network 102 may be in communication with one or more access networks 120 and 122, and the Internet (not shown). In one example, network 102 may combine core network components of a cellular network with components of a triple play service network; where triple-play services include telephone services, Internet services, and multimedia services to subscribers. For example, network 102 may functionally comprise a fixed mobile convergence (FMC) network, e.g., an IP Multimedia Subsystem (IMS) network. In addition, network 102 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. Network 102 may further comprise a streaming service network for streaming of multimedia content to subscribers, or a broadcast television network, e.g., a traditional cable provider network or an Internet Protocol Television (IPTV) network, as well as an Internet Service Provider (ISP) network. In one example, network 102 may include a plurality of television (TV) servers (e.g., a broadcast server, a cable head-end), a plurality of content servers, an advertising server (AS), an interactive TV/video on demand (VoD) server, and so forth.

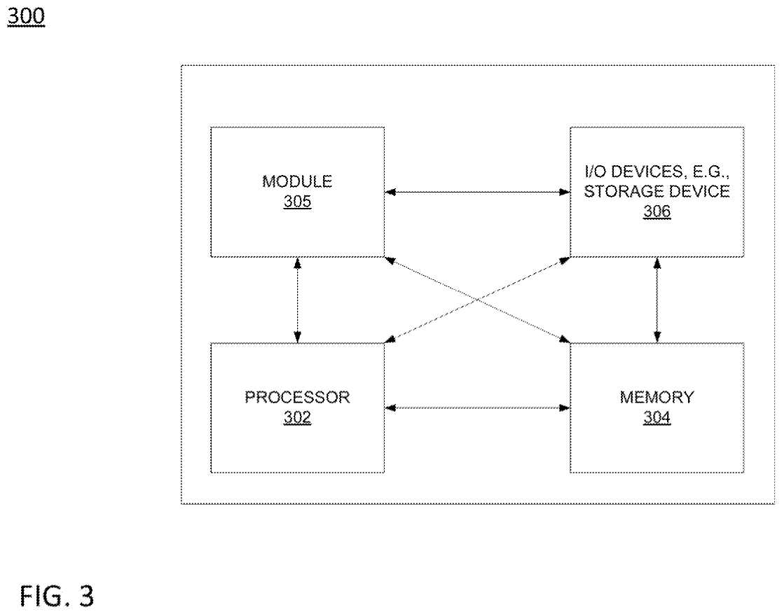

In accordance with the present disclosure, application server (AS) 104 may comprise a computing system or server, such as computing system 300 depicted in FIG. 3, and may be configured to provide one or more operations or functions for performing at least one action in accordance with an output of at least one machine learning model that is activated based on at least a first objective associated with a demeanor of at least a first participant of a network-based conversation, as described herein. It should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 3 and discussed below) or multiple computing devices collectively configured to perform various steps, functions, and/or operations in accordance with the present disclosure.

Thus, although only a single application server (AS) 104 is illustrated, it should be noted that any number of servers may be deployed, and which may operate in a distributed and/or coordinated manner as a processing system to perform operations for performing at least one action in accordance with an output of at least one machine learning model that is activated based on at least a first objective associated with a demeanor of at least a first participant of a network-based conversation, in accordance with the present disclosure. In one example, AS 104 may comprise a physical storage device (e.g., a database server), to store various types of information in support of systems for performing at least one action in accordance with an output of at least one machine learning model that is activated based on at least a first objective associated with a demeanor of at least a first participant of a network-based conversation. For example, AS 104 may store one or more machine learning or artificial intelligence models, which, in accordance with the present disclosure, may include: one or more demeanor detection models, one or more demeanor and/or language transformation models, and/or one or more text-to-speech models that may be deployed by AS 104 in connection with network-based communication sessions. AS 104 may further create and/or store configuration settings for various users, households, employers, service providers, and so forth which may be utilized by AS 104. For instance, user/participant profiles may include objectives/goals that may be selected by participants for a conversation, the MLM(s) corresponding to different objectives, e.g., to determine which MLM(s) to deploy and when, which actions to deploy in response to MLM outputs (e.g., warnings/alerts and/or modification of conversation content). For ease of illustration, various additional elements of network 102 are omitted from FIG. 1.

In one example, the access networks 120 and 122 may comprise Digital Subscriber Line (DSL) networks, public switched telephone network (PSTN) access networks, broadband cable access networks, Local Area Networks (LANs), wireless access networks (e.g., an IEEE 802.11/Wi-Fi network and the like), cellular access networks, 3^{rd} party networks, and the like. For example, the operator of network 102 may provide a multimedia streaming service, a cable television service, an IPTV service, or any other types of telecommunication service to subscribers via access networks 120 and 122. In one example, the access networks 120 and 122 may comprise different types of access networks, may comprise the same type of access network, or some access networks may be the same type of access network and others may be different types of access networks. In one example, the network 102 may be operated by a telecommunication network service provider. The network 102 and the access networks 120 and 122 may be operated by different service providers, the same service provider or a combination thereof, or may be operated by entities having core businesses that are not related to telecommunications services, e.g., corporate, governmental or educational institution LANs, and the like.

In one example, the access network 120 may be in communication with a device 141. Similarly, access network 122 may be in communication with one or more devices, e.g., device 142. Access networks 120 and 122 may transmit and receive communications between devices 141 and 142, between devices 141 and 142, and application server (AS) 104, other components of network 102, devices reachable via the Internet in general, and so forth. In one example, each of devices 141 and 142 may comprise any single device or combination of devices that may comprise a user endpoint device. For example, the devices 141 and 142 may each comprise a mobile device, a cellular smart phone, a wearable computing device (e.g., smart glasses or smart goggles), a laptop, a tablet computer, a desktop computer, an application server, a bank or cluster of such devices, and the like. In one example, devices 141 and 142 may each comprise programs, logic or instructions for performing at least one action in accordance with an output of at least one machine learning model that is activated based on at least a first objective associated with a demeanor of at least a first participant of a network-based conversation. For example, devices 141 and 142 may each comprise a computing system or device, such as computing system 300 depicted in FIG. 3, and may be configured to provide one or more operations or functions in connection with examples of the present disclosure for performing at least one action in accordance with an output of at least one machine learning model that is activated based on at least a first objective associated with a demeanor of at least a first participant of a network-based conversation, as described herein.

As illustrated in FIG. 1, the device 141 may be associated with a first participant 191 and may comprise a mobile computing device with a camera, a microphone, a touch screen and/or keyboard, and so forth. Similarly, the device 142 may be associated with a second participant 192 and may also comprise a mobile computing device with a camera, a microphone, a touch screen and/or keyboard, and so forth. In one example, the devices 141 and 142 may each present text, audio, and/or visual content of one or more other participants to a network-based conversation via respective user interfaces and output components (e.g., screens, speakers, or the like). As illustrated in FIG. 1, the first participant 191 may also have a wearable device/biometric sensor device 143 which may measure, record, and/or transmit one or more types of biometric data, such as a heart rate, a breathing rate, a skin conductance, and so on. In one example, biometric sensor device 143 may include transceivers for wireless communications, e.g., for Institute for Electrical and Electronics Engineers (IEEE) 802.11 based communications (e.g., “Wi-Fi”), IEEE 802.15 based communications (e.g., “Bluetooth”, “ZigBee”, etc.), cellular communication (e.g., 3G, 4G/LTE, 5G, etc.), and so forth. As such, biometric sensor device 143 may provide various measurements to device 141 and/or to AS 104 (e.g., via device 141 and/or via access network 120).

In one example, devices 141 and 142 may communicate with each other and/or with AS 104 to establish, maintain/operate, and/or tear-down a network-based communication session. In one example, AS 104 and device 141 and/or device 142 may operate in a distributed and/or coordinated manner to perform various steps, functions, and/or operations described herein. In an illustrative example, AS 104 may establish and maintain a communication session between devices 141 and 142, and may store and implement one or more configuration settings specifying both inbound and outbound modifications of conversation content for one or both of the first participant 191 and the second participant 192. For instance, AS 104 may obtain at least a first objective associated with a demeanor of at least the first participant 191 for a network-based conversation via AS 104. For example, the first participant 191 may input the objective via device 141, which may transmit the objective to AS 104. The input may be a text input, a touch screen selection from among a plurality of available objectives, a voice input via a microphone, and so forth. In one example, the first objective may be obtained by AS 104 in advance of the setup of a network-based conversation, or in connection with the initial setup of the network-based conversation. However, in another example, the at least the first objective may be obtained during a network-based communication via AS 104 that is already in progress.

Alternatively, or in addition, device 141 and/or device 142 may indicate a purpose for the network-based communication session (e.g., a conversation context) such as a work collaboration session, a client call, a personal call, a medical consultation call, a complaint call to a customer care center, etc. In this regard, the user 191 may have previously provided to AS 104 one or more objectives to match to different types of conversations (e.g., different contexts). Alternatively, or in addition, AS 104 may infer objectives based on a stated topic or purpose of the conversation and one or more past conversations for the same or different participant(s). In one example, AS 104 may determine that an objective of the first participant 191 is applicable in the context(s) of the current conversations. The context(s) may include, the purpose of the conversation, the time of the conversation, the parties to the conversation and any prior relationship between the parties, biometric data of one or more parties, the modality of the conversation (e.g., text, voice, video, etc.), and so forth.

In response to obtaining the at least the first objective, AS 104 may then activate at least one machine learning model (MLM) associated with the at least the first objective (e.g., load the at least one MLM into memory in readiness for application to the conversation content). If not already established, AS 104 may set-up a network-based communication session/conversation to be monitored. The network-based communication session (e.g., a network-based conversation) may be established by AS 104 via access network 120, access network 122, network 102, and/or the Internet in general. The establishment may include providing security keys, tokens, certificates, or the like to encrypt and to protect the media streams between devices 141 and 142 with AS 104 when in transit via one or more networks, and to allow devices 141 and 142 to decrypt and present received conversation content. In one example, the establishment of the network-based communication session may further include reserving network resources of one or more networks (e.g., network 102, access networks 120 and 122, etc.) to support a particular quality of service (QoS) for the communication session (e.g., a certain video resolution, a certain audio quality, a certain delay measure, and/or a certain packet loss ratio, and so forth). Such reservation of resources may include an assignment of slots in priority queues of one or more routers, the use of a particular QoS flag in packet headers which may indicate that packets should be routed with a particular priority level, the establishment and/or use of a certain label-switched path with a guaranteed latency measure for packets of the network-based communication session, and so forth. In one example, AS 104 may establish a communication path such that media streams between device 141 and device 142 pass via AS 104, thereby allowing AS 104 to detect participant dispositions and/or to implement modifications to the communication content. For instance, for a voice call, AS 104 may comprise a Session Initiation Protocol (SIP) back-to-back user agent, or the like, which may remain in the communication path of the conversation content.

In one example, the MLM(s) may be associated with the objective(s), e.g., in accordance with a participant profile of the first participant 191 and/or based upon a default profile or the like that may be accessed by AS 104. In one example, AS 104 may train one or more demeanor detection models, one or more encoder-decoder neural networks or the like for transforming the communication content of one or more participants, one or more text-to-speech models, and so forth (e.g., different machine learning models). It should be noted that as referred to herein, a machine learning model (MLM) (or machine learning-based model) may comprise a machine learning algorithm (MLA) that has been “trained” or configured in accordance with input training data to perform a particular service, e.g., to detect a perceived demeanor/emotional state or a value indicative of such a perceived demeanor, etc. In one example, MLM-based detection models associated with image data inputs may be trained using samples of video or still images that may be labeled by participants or by human observers with demeanors (and/or with other semantic content labels/tags). For instance, a machine learning algorithm (MLA), or machine learning model (MLM) trained via a MLA may be for detecting a single semantic concept, such as a demeanor, or may be for detecting a single semantic concept from a plurality of possible semantic concepts that may be detected via the MLA/MLM (e.g., a set of demeanors, such as multi-class classifier). For instance, the MLA (or the trained MLM) may comprise a deep learning neural network, or deep neural network (DNN), such as convolutional neural network (CNN), a generative adversarial network (GAN), a support vector machine (SVM), e.g., a binary, non-binary, or multi-class classifier, a linear or non-linear classifier, and so forth. In one example, the MLA may incorporate an exponential smoothing algorithm (such as double exponential smoothing, triple exponential smoothing, e.g., Holt-Winters smoothing, and so forth), reinforcement learning (e.g., using positive and negative examples after deployment as a MLM), and so forth. It should be noted that various other types of MLAs and/or MLMs, or other detection models may be implemented in examples of the present disclosure such as a gradient boosted decision tree (GBDT), k-means clustering and/or k-nearest neighbor (KNN) predictive models, support vector machine (SVM)-based classifiers, e.g., a binary classifier and/or a linear binary classifier, a multi-class classifier, a kernel-based SVM, etc., a distance-based classifier, e.g., a Euclidean distance-based classifier, or the like, a SIFT or SURF features-based detection model, as mentioned above, and so on. It should also be noted that various pre-processing or post-recognition/detection operations may also be applied. For example, server(s) 116 may apply an image salience algorithm, an edge detection algorithm, or the like (e.g., as described above) where the results of these algorithms may include additional, or pre-processed input data for the one or more detection models.

With respect to a disposition detection model that uses visual input, the input data may include low-level invariant image data, such as colors (e.g., RGB (red-green-blue) or CYM (cyan-yellow-magenta) raw data (luminance values) from a CCD/photo-sensor array), shapes, color moments, color histograms, edge distribution histograms, etc. Visual features may also relate to movement in a video or other visual sequences (e.g., visual aspects of a data feed of a virtual environment) and may include changes within images and between images in a sequence (e.g., video frames or a sequence of still image shots), such as color histogram differences or a change in color distribution, edge change ratios, standard deviation of pixel intensities, contrast, average brightness, and the like. Alternatively, or in addition, the visual data may also include spatial data, e.g., LiDAR positional data. For instance, a user may be captured in video along with LiDAR positional data that can be represented as a point cloud which may comprise a predictor for training one or more machine learning models. In one example, such a point cloud may be reduced, e.g., via feature matching to provide a lesser number of markers/points to speed the processing of training (and classification for a deployed MLM).

Similarly, AS 104 may train and deploy various speech or other audio-based demeanor detection models, which may be trained from extracted audio features from one or more representative audio samples, such as low-level audio features, including: spectral centroid, spectral roll-off, signal energy, mel-frequency cepstrum coefficients (MFCCs), linear predictor coefficients (LPC), line spectral frequency (LSF) coefficients, loudness coefficients, sharpness of loudness coefficients, spread of loudness coefficients, octave band signal intensities, and so forth, wherein the output of the model in response to a given input set of audio features is a prediction of whether a particular semantic content is or is not present (e.g., sounds indicative of a particular demeanor (e.g., “excited,” “stressed,” “content,” “indifferent,” etc.), the sound of breaking glass (or not), the sound of rain (or not), etc.). For instance, in one example, each audio model may comprise a feature vector representative of a particular sound, or a sequence of sounds.

It is also noted that detection models may be associated with detecting demeanors/emotional states from facial images. For instance, such detection models may include eignefaces representing various dispositions or other moods, mental states, and/or emotional states, or similar SIFT or SURF models. For instance, a quantized vector, or set of quantized vectors representing a demeanor, or other moods, mental states, and/or emotional states in facial images may be encoded using techniques such as principal component analysis (PCA), partial least squares (PLS), sparse coding, vector quantization (VQ), deep neural network encoding, and so forth. Thus, in one example, AS 104 may employ a feature matching detection. For instance, in one example, AS 104 may obtain new content and may calculate the Euclidean distance, Mahalanobis distance measure, or the like between a quantized vector of the facial image data in the content and the feature vector(s) of the detection model(s) to determine if there is a best match (e.g., the shortest distance) or a match over a threshold value.

In still another example, one or more demeanor detection models may be trained to detect one or more demeanors in accordance with biometric data as predictor(s)/input(s). For instance, such model(s) may be configured in accordance with training data mapping biometric data/sensor readings to labeled dispositions. For example, the training data may be obtained from the first participant 191 and/or other users/participants who have self-reported dispositions at different times, which may then be correlated with time-stamped biometric data, e.g., a reporting of being “stressed” or “agitated” can be correlated to a particular heart rate for a particular participant.

In one example, demeanor may be quantified along multiple demeanor/emotional state/mood scales. For instance, mood scales may relate to Profile of Mood States (POMS) six mood subscales (tension, depression, anger, vigor, fatigue, and confusion) or a similar set of Positive Activation-Negative Activation (PANA) model subscales. In one example, AS 104 may not determine a single mood (or demeanor) that best characterizes a facial image, but may obtain a value for each mood that indicates how well the image matches to a mood. In one example, the distance determined for each mood may be matched to a mood scale (e.g., “not at all,” “a little bit,” “moderately,” “quite a lot,” such as according to the POMS methodology). In addition, each level on the mood scale may be associated with a respective value (e.g., ranging from zero (0) for “not at all” to (4) for “quite a lot”). In one example, AS 104 may determine an overall level to which a participant exhibits a particular demeanor/mood (and for multiple possible demeanors/moods) in accordance with the values determined for demeanors/moods. For example, AS 104 may sum values for negative moods/subscales and subtract this total from a sum of values for positive moods/subscales from multiple instances of image data from device 141 or the like. Alternatively, or in addition, AS 104 may calculate scores for certain subscales (e.g., tension, depression, anger, fatigue, confusion, vigor, or the like) comprising composites of different values for component mental states, moods, or emotional states (broadly “demeanors”).

In addition to demeanor detection models, MLMs of the present disclosure may also include demeanor and/or language transformation models. For instance, this may include an encoder-decoder neural network that may transform input communication content (e.g., speech and/or text) into a modified communication content (e.g., speech and/or text). For instance, the transformation may include a transformation to a different tone or demeanor (e.g., the same semantic content, but with less anger, more anger, etc. (e.g., by adjustments of tone, pitch, speed of delivery, cadence, etc.)). In one example, the transformation may include a change in the textual content (e.g., different words or phrasing to convey the same semantics, but with a different demeanor).

For instance, in the example of FIG. 1, a transformation of the speech 150, “How lazy are you? I put the claim in three weeks ago. When will it be done?!” may be transformed into the output speech 152, “The claim seems to be outside the normal processing time. I put the claim in three weeks ago. Is there any way to expedite?” In addition, the transformation may further include a language translation (e.g., from French to English, or the like). In an example of a visual communication session (e.g., a video call) the transformation may also include a facial expression modification (e.g., from an angry face of the first participant 191 to the happy/neutral presented face 151 that may be provided to the second participant 192 at device 142, e.g., the avatar of participant 191 can be changed, the facial features of participant 191 can be altered or masked, etc.).

In one example, AS 104 may also train and store a speech-to-text conversion model. In one example, AS 104 may also train and store one or more text-to-speech models that is/are configured to output generated speech, such as a deep convolutional neural network, a recurrent neural network with vocoder, a WaveNet-based text-to-speech synthesizer, e.g., an autoencoder, or the like. In one example, a text-to-speech model may be configured to output the generated speech that is representative of a voice of a particular participant, e.g., pre-trained on the voice of the first participant 191, for instance. The uses of various machine learning models in the context of the present disclosure are described in greater detail below.

In an illustrative example, the conversation content may include recorded voice data of both participants via devices 141 and 142, respectively. Alternatively, or in addition, for a video call, the conversation content may include recorded image data (e.g., video) from devices 141 and 142. In still another example, the conversation content may alternatively or additional include text/text-based content, such as short message service (SMS)/text messages, emails, over-the-top messaging application messages, or the like. Accordingly, AS 104 may obtain the conversation content (e.g., from at least device 141, and in one example, from device 142 as well) and may apply the conversation content of at least the first participant 191 as at least a first input to at least one machine learning model. In one example, AS 104 may further apply one or more secondary inputs to the at least one machine learning model. For instance AS 104 may obtain biometric data of the at least the first participant 191, e.g., from biometric sensor device 143, which may be input to the at least one machine learning model. Similarly, AS 104 may obtain image data of the at least the first participant 191 (if the image data is part of the conversation content, such as for a video call), where the image data may comprise a secondary input to the at least one machine learning model.

In one example, the at least one machine learning model may comprise a demeanor detection model that is configured to detect at least a first demeanor from the conversation content of the first participant 191. In one example, the at least the first objective comprises an objective of the first participant 191 to convey a selected demeanor to the second participant 192, e.g., calm, angry, upset, etc. In one example, the output of the at least one machine learning model comprises an indicator of a discrepancy between the at least the first demeanor and the selected demeanor. In another example, an objective of the first participant 191 may be to align conversation content of the first participant 191 with a demeanor of the first participant 191 during the conversation. For instance, the at least one machine learning model may comprise at least two machine learning models, which may include a first demeanor detection model (e.g., an emotional state detection model) that is configured to detect a first demeanor from the conversation content and a second demeanor detection model that is configured to detect a second demeanor from the at least the second input (e.g., biometric data and/or image data). Notably, in this example, the semantics and tone of the first participant 191 are not considered to be indicative of the disposition. Rather, the biometric and/or image data of the first participant 191 is considered indicative of the demeanor, where the semantics (e.g., language) and/or tone, pitch, etc. of the first participant 191 is be aligned thereto. In another example, not pictured in FIG. 1, the first participant 191 and second participant 192 may be engaged in a negotiation over a price, product, or service. In this example, the typical responses of the first participant 191 may be very emotionally charged (e.g. excited for positive progress in the negotiation or overwhelmingly negative for negative progress), but AS 104 can normalize these visual, audible, and content-centric responses to best advance the intent of the conversation.

AS 104 may next obtain an output of the at least one machine learning model, e.g., in response to the conversation content of the at least the first participant 191 as the at least one input. For instance, in one example, the output of the at least one machine learning model may comprise an indicator of a discrepancy between a demeanor determined from the conversation content and a demeanor determined from secondary input(s), an indicator of a discrepancy between a demeanor determined from the conversation content and a demeanor specified as an objective of the conversation, or the like. AS 104 may then perform at least one action in accordance with the output. For instance, AS 104 may present an indicator to the first participant 191 of the discrepancy. Alternatively, or in addition, the at least one action may comprise altering the conversation content of the first participant 191 to align to a selected demeanor (e.g., specified in the objective(s) or as determined from the secondary input(s) to the one or more machine learning models). For example, the altering of the conversation content may comprise AS 104 applying the conversation content of the first participant 191 as an input to an encoder-decoder neural network, or the like, where an output comprises an altered conversation content of the first participant 191, and where the altering may relate to the semantics (language) and/or, with respect to verbal/audio communication, may apply to the tone, volume/pitch, and so forth.

In one example, the conversation content may comprise recorded speech and the altering may further comprise performing a speech-to-text conversion to obtain a generated text, where the generated text comprises the input to the encoder-decoder neural network. In such an example, the alerting may further include applying the altered conversation content of the first participant 191 to a text-to-speech module that is configured to output generated speech, such as a deep convolutional neural network, a recurrent neural network with vocoder, a WaveNet-based text-to-speech synthesizer, e.g., an autoencoder, or the like. In one example, the text-to-speech module is configured to output the generated speech that is representative of a voice of the at least the first participant, e.g., pre-trained on the voice of the at least the first participant. In one example, the at least one action may further include AS 104 presenting the altered conversation content to at least the second participant 192, e.g., via one or more communications to device 142. In one example, the altered conversation content may be of a different language than the conversation content of the first participant 191 (e.g., the language used by the first participant 191) For example, the encoder-decoder neural network may also be configured to translate from a first language of the conversation content to a second language of the altered conversation content.

The foregoing describes an example of a network-based service via AS 104. However, it should be understood that in other, further, and different examples, the detection of demeanors and/or the modifications of communication content may alternatively or additionally be applied locally, e.g., at device 141 and/or at device 142, via a home network gateway or hub via which device 141 or device 142 may connect to access network 120 or 122, and so forth. It should also be noted that the foregoing describes example objectives and example actions in accordance with participant selections. However, in one example, additional objective(s) and corresponding actions may be applied for participants' outbound and/or inbound communication content as directed by employers, head of household/account holders (e.g., for users who are children), and so forth.

In one example, a network-based communication session may be established with more than two participants via AS 104. In one example, a network-based communication session may comprise a virtual reality interaction between participants within a virtual reality space, an augmented reality interaction between participants, or the like. In one example, AS 104 may support the creation of demeanor detection models and associated objectives. For example, participant configuration settings may map actions and demeanor detection models with applicable contexts to activate: the objectives, demeanor detection models, and/or corresponding actions (e.g., notifications of deviations of demeanor and communication content and/or automatic modifications to communication, etc.). The models, objectives, and actions can be created for a single user/participant, can be created for a group of users, can be created for all users and made available for selection by users to activate (e.g., model profiles and/or default configuration settings), and so on. In one example, participant preferences may be learned over time from prior network-based conversations.

In addition, the foregoing is described primarily in connection with outbound communications, e.g., applying communication content of the first participant 191 to one or more MLMs, modifying the communication content of the first participant 191, etc. However, AS 104 may also apply conversation content of the second participant 192 to one or more MLMs in accordance with one or more objectives of the first participant 191. For instance, the first participant 191 may have an objective to not become angry, but may have difficulty in doing so when an opposite party is also reacting angrily or the topic of discussion promotes the first participant 191 to become angry over time. In this case, the conversation content of the second participant 192 may be applied, e.g., to an encoder-decoder network or the like, to generate a modified conversation content of the second participant 192 that may be more neutral in tone, lower in volume, less confrontational in the word choice and/or phrasing utilized, etc.

In addition, the foregoing is described primarily in connection with an example of one or more objectives of the first participant 191, the application of conversation content of the first participant 191 to one or more MLMs, and the corresponding action(s) with respect to notification of the first participant 191 and/or the modification of the communication content thereof. However, in another example, AS 104 may equally serve the objectives of the second participant 192. In one example, AS 104 may separately serve the objectives of all of the participants. In another example, AS 104 may jointly serve the objectives of the participants (e.g., balancing between an objective of the first participant 191 to discuss a particular topic and to convey a sense of anger, and an objective of the second participant 192 to not be upset during the conversation, or the like). As noted above, in one example, aspects described with respect to AS 104 may alternatively or additionally be deployed to device 141 and/or to device 142. As such, objectives of the respective participants may be served by their respective endpoint devices. However, in another example, separate network-based services may be deployed for the respective participants unilaterally. For instance, two separate servers, virtual machines running on separate hardware, or the like may be in the communication path as proxies between the respective devices 141 and 142 in access networks 120 and/or 122, network 102, or the like. Thus, these and other modifications are all contemplated within the scope of the present disclosure.

It should also be noted that the system 100 has been simplified. Thus, it should be noted that the system 100 may be implemented in a different form than that which is illustrated in FIG. 1, or may be expanded by including additional endpoint devices, access networks, network elements, application servers, etc. without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements. For example, the system 100 may include other network elements (not shown) such as border elements, routers, switches, policy servers, security devices, gateways, a content distribution network (CDN) and the like. For example, portions of network 102, access networks 120 and 122, and/or Internet may comprise a content distribution network (CDN) having ingest servers, edge servers, and the like for packet-based streaming of video, audio, or other content. Similarly, although only two access networks, 120 and 122 are shown, in other examples, access networks 120 and/or 122 may each comprise a plurality of different access networks that may interface with network 102 independently or in a chained manner. In one example, the system 100 may further include wireless or wired connections to external sensors, such as temperature sensors, movement sensors, external cameras which my capture video or other image data of a participant, and so forth, which may be used to determine participant demeanors or the like. Thus, these and other modifications are all contemplated within the scope of the present disclosure.

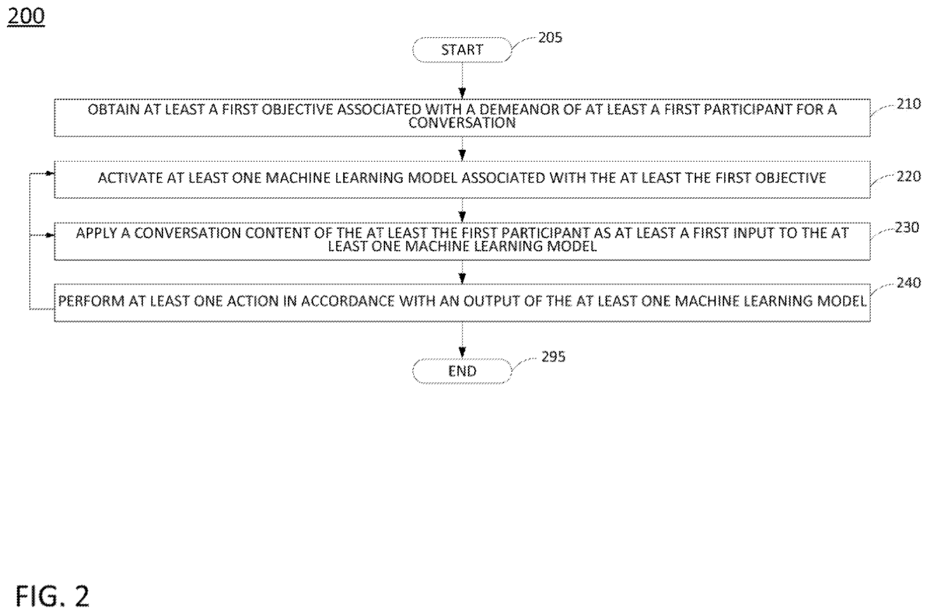

FIG. 2 illustrates a flowchart of an example method 200 for performing at least one action in accordance with an output of at least one machine learning model that is activated based on at least a first objective associated with a demeanor of at least a first participant of a network-based conversation, in accordance with the present disclosure. In one example, the method 200 is performed by a component of the system 100 of FIG. 1, such as by application server 104, device 141, or device 142, and/or any one or more components thereof (e.g., a processor, or processors, performing operations stored in and loaded from a memory), or by application server 104, in conjunction with one or more other devices, such as device 141, device 142, biometric sensor device 143, and so forth. In one example, the steps, functions, or operations of method 200 may be performed by a computing device or system 300, and/or processor 302 as described in connection with FIG. 3 below. For instance, the computing device or system 300 may represent any one or more components of application server 104, device 141, or device 142 in FIG. 1 that is/are configured to perform the steps, functions and/or operations of the method 200. Similarly, in one example, the steps, functions, or operations of method 200 may be performed by a processing system comprising one or more computing devices collectively configured to perform various steps, functions, and/or operations of the method 200. For instance, multiple instances of the computing device or processing system 300 may collectively function as a processing system. For illustrative purposes, the method 200 is described in greater detail below in connection with an example performed by a processing system. The method 200 begins in step 205 and proceeds to step 210.

At step 210, the processing system obtains at least a first objective associated with a demeanor of at least a first participant for a conversation (e.g., a network-based conversation). In various examples, the conversation may comprise at least one of a text-based conversation, a speech-based conversation, or a video-based conversation. In one example, different modes of communication may be used by different participants. For instance, the first participant may communicate speech/audio and video data to one or more other participants, while another participant may communicate audio only. Other combinations may similarly be used depending on participant preferences, device capabilities, and so forth. In one example, the first participant may use text, while at least one other participant may use speech (or vice versa). In one example, speech-to-text conversion and/or text-to-speech conversion may be used such that inbound and outbound communications for a single user remain in a same mode, while one or more other users may similarly have inbound and outbound communications in a same mode (which may be different from a mode for a different participant). It should be understood that video may include two-dimensional video, volumetric video, VR/AR (or XR) that may include realistic user images and/or avatars, etc. In one example, the processing system may be in the communication path of the conversation content of the conversation. For instance, the processing system may be deployed in a network (e.g., a telecommunication network) between endpoint devices of the participants. In another example, the processing system may be deployed on one or multiple endpoint devices of the participants, on a gateway, home router, or the like associated with one or multiple participants, and so forth.

In one example, the at least the first objective may comprise an objective of the at least the first participant to align conversation content of the at least the first participant with the demeanor of the first participant during the conversation. Alternatively, or in addition, the at least the first objective may comprise an objective of the at least the first participant to convey a selected demeanor to at least a second participant, e.g., calm, angry, upset, etc. In still other examples, the at least the first objective may alternatively or additionally include an objective of the at least the first participant to reach an agreement with at least a second participant, an objective to not upset at least a second participant, an objective to discuss one or more particular topics, and so forth. In one example, the at least the first objective may be selected from a set of available objectives. For instance, there may be various machine learning models that are trained and available for activation/use in connection with particular predefined objectives. Thus, it may be from among these objectives that the at least the first participant may select one or more objectives for a current conversation.

In various examples, the at least the first objective may be obtained in accordance with at least one input of the at least the first participant and/or determined in accordance with one or more factors. For instance, the one or more factors may include: a user profile of the at least the first participant, a user profile of at least a second participant, a relationship between the at least the first participant and the at least the second participant (e.g. social, professional, or customer and service provider, etc.), at least one communication modality of the conversation, at least one location of at least one of the at least the first participant or the at least the second participant, at least one topic of the conversation, and so forth. In one example, step 210 may include obtaining at least a second objective of at least a second participant for the conversation. For instance, the at least the second objective may be of a same or similar nature as the at least the first objective as described above. For example, the second objective may be for the second participant as recipient of the conversation content of the first participant, where the second participant may prefer to hear/see what the other participant is conveying, but without an angry tone or emotion. Similarly, the second participant may have a hard time avoiding reacting in an angry manner when the first participant is speaking in an angry tone which may risk ruining the conversation and escalating an existing conflict. As such, the second participant may prefer to tone down the communication content of the first participant so as to prevent the second participant from overreacting. In one example, step 210 may include obtaining a select of the at least the first participant of features that the processing system is permitted to obtain and/or access for purposes of demeanor detection (e.g., heart rate data is allowed, but facial image data is denied).

At step 220, the processing system activates at least one machine learning model associated with the at least the first objective. For instance, the processing system may access the at least one machine learning model from a repository attached to or otherwise accessible to the processing system, may load the at least one MLM into memory in readiness for application to the conversation content, and so forth. In one example, the at least one machine learning model may comprise a demeanor detection model that is configured to detect at least a first demeanor from at least a first input (e.g., the conversation content of the at least the first participant). In one example, the at least one machine learning model may comprise at least two machine learning models, e.g., at least a first demeanor detection model that is configured to detect a first demeanor from at least a first input and a second demeanor detection model that is configured to detect a second demeanor from at least a second input.

In one example, there may be different demeanor detection models that are for detecting particular demeanors (e.g., binary classifiers). In one example, one or more selected demeanor detection models may be activated (from among a larger plurality of available demeanor detection models) based upon one or more contextual factors, such as the identity of the at least the first participant and the propensities of the at least the first participant that may be indicated in a user/participant profile (e.g., the disposition(s) of the at least the first participant), the identity of at least a second participant and/or a relationship to the at least the first participant, a history of communications between the participants (e.g., are the communications usually friendly, contentious, etc.), all of which may be recorded in either or both user profiles, a current topic of conversation (which may be associated with particular dispositions (e.g., customer service calls are more likely to result in “negative” demeanors as compared to a call between friends to schedule a get-together, for example)), and so forth. In one example, the at least the first participant may indicate one or more anticipated demeanors, for which one or more associated detection models may be activated. In one example, the at least one machine learning model may be further associated with at least a second objective. For instance, step 220 may include activating at least a second machine learning model that is associated with the at least the second objective. In another example, the first machine learning model may serve the dual objectives of the first participant and the second participant. In one example, the first participant may provide as input (or as a profile attribute in their interactions with the system), a minimal and maximal value that defines a tolerance for model activation. For instance, in a three-part negative emotion scale from “neutral” to “frustration” to the highest level “furious”, the first participant may want the model to activate only for those detected emotions below “frustration”.

At step 230, the processing system applies a conversation content of the at least the first participant as at least a first input to the at least one machine learning model. In one example, the conversation content of the at least the first participant may comprise recorded speech. As noted above, the conversation content of the at least the first participant may additionally comprise captured image data of the at least the first participant. In one example, the conversation content of the at least the first participant may comprise text content. In one example, step 230 may include performing a speech-to-text conversion, where the resulting text may comprise the at least the first input. Alternatively, or in addition, the at least one machine learning model may include a speech-to-text module (e.g., a separate machine learning model in addition to others). The at least one machine learning model may comprise a demeanor detection model that is configured to detect at least a first demeanor from the at least the first input (and/or one or more demeanor detection models for different demeanors).

In one example, step 230 may include extracting various features of the conversation content as inputs to the at least one machine learning model, such as, for audio/voice content: spectral centroid, spectral roll-off, signal energy, MFCCs, LPCs, LSF coefficients, loudness coefficients, sharpness of loudness coefficients, spread of loudness coefficients, octave band signal intensities, and so forth. Similarly, with respect to a machine learning model (e.g., a disposition detection model) that uses visual input, the input data may include low-level invariant image data, such as colors, shapes, color moments, color histograms, edge distribution histograms, changes within images and between images in a sequence, such as color histogram differences or a change in color distribution, edge change ratios, standard deviation of pixel intensities, contrast, average brightness, and the like. Alternatively, such features may be extracted by the at least one machine learning model, e.g., from raw audio and/or image data as input(s). In an example in which the objective comprises an objective of the at least the first participant to convey a selected demeanor to at least the second participant, the output of the at least one machine learning model may comprise an indicator of a discrepancy between the at least the first demeanor and the selected demeanor (e.g., the demeanor detection model may be for detecting the selected demeanor, and the output may be whether the selected demeanor is detected from the first input or not).

In one example, step 230 may include applying at least a second input to the at least one machine learning model, wherein the at least the second input comprises at least one of: biometric data of the at least the first participant or image data of the at least the first participant (where the latter may be used when not part of the conversation content). As further noted above, the at least one machine learning model may comprise at least two machine learning models, e.g., at least a first demeanor detection model that is configured to detect a first demeanor from at least the first input (the conversation content of the at least the first user) and a second demeanor detection model that is configured to detect a second demeanor from at least the second input. Thus, in one example, step 230 may include applying the second input to the second demeanor detection model. In one example, the output of the at least one machine learning model may comprise an indicator of a discrepancy between the first demeanor (that may be output from the first demeanor detection model) and the second demeanor (that may be output from the second demeanor detection model).

At step 240, the processing system performs at least one action in accordance with an output of the at least one machine learning model, e.g., in response to the conversation content of the at least the first user as the at least one input. For instance, in one example, step 240 may include presenting an indicator to the at least the first participant of a discrepancy, e.g., between a detected demeanor and a selected demeanor in accordance with the at least the first objective, between a first demeanor and a second demeanor detected via first and second demeanor detection models, respectively, or the like. In one example, the at least one action may further include presenting a suggestion to speak more calmly, or to convey additional anger, etc. In one example, the presenting may also include presenting an option to activate an emotional/dispositional transcoding (e.g., as described below).

In one example, the at least one action may alternatively or additionally comprise altering the conversation content of the at least the first participant to align to a selected demeanor (e.g., emotional/dispositional transcoding). For instance the selected demeanor may be specified by the at least the first participant as described above, or may be a demeanor that may be detected in accordance with the at least the second input at step 230. In one example, the altering may include applying the conversation content of the at least the first participant as an input to a transformer, e.g., an encoder-decoder neural network or the like, where an output comprises an altered conversation content of the at least the first participant. In this regard, in an example in which the conversation content of the at least the first participant comprises recorded speech, the altering may further comprise performing a speech-to-text conversion to obtain a generated text, where the generated text comprises the input to the encoder-decoder neural network. In addition, the altering may further include applying the altered conversation content of the at least the first participant (e.g., an output of the encoder-decoder neural network (or other generative machine learning models similarly configured)) to a text-to-speech module that is configured to output generated speech. For instance, the text-to-speech model may comprise a deep convolutional neural network, a recurrent neural network with vocoder, a WaveNet-based text-to-speech synthesizer, e.g., an autoencoder, or the like. In one example, such a text-to-speech module may be configured to output generated speech that is representative of a voice of the at least the first participant. For instance, the text-to-speech module may be pre-trained on the voice of the at least the first participant. In one example, the transformation may include a transformation to a different tone or demeanor (e.g., the same semantic content, but with less anger, more anger, etc. (e.g., by adjustments of one or more of: tone, pitch, speed of delivery, cadence, and so forth)). In one example, the transformation may alternatively or additionally include a change in the textual content (e.g., different words or phrasing to convey the same semantics, but with a different demeanor).

In one example, the at least one action may further comprise presenting the altered conversation content of the at least the first participant to at least a second participant of the conversation. In one example, the altered conversation content may be of a different language than the conversation content of the at least the first participant. In other words, the encoder-decoder neural network may be further configured to translate from a first language of the conversation content to a second language of the altered conversation content. In addition, in an example in which the conversation content of the at least the first participant comprises captured image data of the at least the first participant, the altering may further comprise applying the captured image data to the encoder-decoder neural network, where the output of the encoder-decoder neural network may further comprise generated image data of the at least the first participant. For instance, the encoder-decoder neural network may be trained from prior image data (e.g., video and/or still images from various poses) of the at least the first participant. In one example, the image data may be limited to facial data, but could also include additional aspects, such as upper body, which can convey demeanor via gestures/mannerisms, e.g., hand, arm, shoulder, neck, or other movements or poses that accompany speech. In this regard, it should also be noted that in one example, the encoder-decoder neural network may comprise a generative model that is individualized to the first participant. For instance, the encoder-decoder neural network can be generated by the first participant and applied with the first participant's permission and under the direction and control of the first participant for the first participant's benefit.

In one example, the at least one action may include presenting an intended altered conversation content to the first participant for approval prior to presenting to the at least the second participant. For instance, the first participant may deny/override the recommendation from the system, the first participant may select a different type of alteration than that which is suggested by the processing system, and so forth. It should also be noted that in one example, the at least one machine learning model may comprise at least a first machine learning model that is associated with the at least the first objective and at least a second machine learning model that is associated with the at least the second objective (e.g., of at least the second participant). In such case, step 230 may further comprise applying second conversation content of the at least the second user to the at least the second machine learning model, and the at least one action of step 240 may further comprise at least a second action that is in accordance with at least the second output of the at least second machine learning model. For instance, the second action may be of a same or similar nature as the actions described above.

Following step 240, the method 200 proceeds to step 295 where the method ends.

It should be noted that the method 200 may be expanded to include additional steps, or may be modified to replace steps with different steps, to combine steps, to omit steps, to perform steps in a different order, and so forth. For instance, in one example the processor may repeat one or more steps of the method 200, such as steps 210-240 for different conversations, steps 230-240 on an ongoing basis during the conversation, and so forth. In one example, step 240 may provide a feedback loop to step 220 for continual learning and refinement of the at least one machine learning model in step 220. In one example, the method 200 may further include receiving a request to establish a communication session (e.g., the network-based conversation) from an endpoint device of the first participant and/or the second participant. In one example, the method 200 may further include establishing a communication session (e.g., the network-based conversation) between endpoint devices of at least the first and second participants. As noted above, the conversation may include text-based conversations, such as via email, SMS message, or over-the-top messaging application, voice-based conversations/voice calls, video calls, and so forth. In one example, a communication session may be via a group video call, an AR or VR session, a massive multiplayer online game (MMOG), or the like.

In one example, the conversation content may be applied to an encoder-decoder neural network to generated altered conversation content on an ongoing basis (e.g., continuously during the conversation). For instance, a separate demeanor detection model (or models) may be omitted. The encoder-decoder neural network may alter the conversation content if it is not aligned to a selected demeanor. However, if the input is aligned to the selected demeanor, there may be no alteration, or little alteration. In such case, step 230 may include applying the conversation content to the encoder-decoder neural network, and 240 may include presenting the altered conversation content (generative output) to at least the second participant. In still another example, the method 200 may be expanded to include initial demeanor detection prior to the conversation (e.g., via biometric data) and then selecting objective(s) and/or one or more machine learning models to activate in response to the prior-determined demeanor.

In one example, the method 200 may further include training various machine learning models, such as disposition detection models with respect to conversation content input(s), disposition detection models with respect to biometric data input(s), encoder-decoder neural networks or other generative models for generating altered conversation content, one or more text-to-speech models, or modules (which in one example may be further individualized to respective participants/users), and so forth. In one example, any user override of recommended/intended alterations may be noted and used for retraining the at least one machine learning model, e.g., in a reinforcement learning framework. In one example, the method 200 may further include recording the conversational information (e.g. the reduction in tone, emotion, or recasting of specific content details), which may be distributed or archived via a secondary channel for later use by either the first participant, second participant, or the system itself. This optional step may help any of these parties learn from modifications that were deemed necessary (to avoid information loss) but which were either not critical (or detrimental) to being received at the time of the conversation itself. In one example, the method 200 may further include the processing system collecting baseline biometric data of the at least the first participant, such as eyeball movement, heart rate, etc., and training the at least the first demeanor detection model with such data as at least a portion of the training data/inputs (e.g., as negative examples associated with extreme demeanors, as positive examples associated with neutral demeanors). In various other examples, the method 200 may further include or may be modified to comprise aspects of any of the above-described examples in connection with FIG. 1, or as otherwise described in the present disclosure. Thus, these and other modifications are all contemplated within the scope of the present disclosure.

In addition, although not expressly specified above, one or more steps of the method 200 may include a storing, displaying and/or outputting step as required for a particular application. In other words, any data, records, fields, and/or intermediate results discussed in the method can be stored, displayed and/or outputted to another device as required for a particular application. Furthermore, operations, steps, or blocks in FIG. 2 that recite a determining operation or involve a decision do not necessarily require that both branches of the determining operation be practiced. In other words, one of the branches of the determining operation can be deemed as an optional step. Furthermore, operations, steps or blocks of the above described method(s) can be combined, separated, and/or performed in a different order from that described above, without departing from the example embodiments of the present disclosure.

FIG. 3 depicts a high-level block diagram of a computing device or processing system specifically programmed to perform the functions described herein. For example, any one or more components or devices illustrated in FIG. 1 or described in connection with the method 200 may be implemented as the processing system 300. As depicted in FIG. 3, the processing system 300 comprises one or more hardware processor elements 302 (e.g., a microprocessor, a central processing unit (CPU) and the like), a memory 304, (e.g., random access memory (RAM), read only memory (ROM), a disk drive, an optical drive, a magnetic drive, and/or a Universal Serial Bus (USB) drive), a module 305 for performing at least one action in accordance with an output of at least one machine learning model that is activated based on at least a first objective associated with a demeanor of at least a first participant of a network-based conversation, and various input/output devices 306, e.g., a camera, a video camera, storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like).

Although only one processor element is shown, it should be noted that the computing device may employ a plurality of processor elements. Furthermore, although only one computing device is shown in the Figure, if the method(s) as discussed above is implemented in a distributed or parallel manner for a particular illustrative example, i.e., the steps of the above method(s) or the entire method(s) are implemented across multiple or parallel computing devices, e.g., a processing system, then the computing device of this Figure is intended to represent each of those multiple general-purpose computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 302 can also be configured or programmed to cause other devices to perform one or more operations as discussed above. In other words, the hardware processor 302 may serve the function of a central controller directing other devices to perform the one or more operations as discussed above.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computing device, or any other hardware equivalents, e.g., computer readable instructions pertaining to the method(s) discussed above can be used to configure a hardware processor to perform the steps, functions and/or operations of the above disclosed method(s). In one example, instructions and data for the present module or process 305 for performing at least one action in accordance with an output of at least one machine learning model that is activated based on at least a first objective associated with a demeanor of at least a first participant of a network-based conversation (e.g., a software program comprising computer-executable instructions) can be loaded into memory 304 and executed by hardware processor element 302 to implement the steps, functions or operations as discussed above in connection with the example method 200. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 305 for performing at least one action in accordance with an output of at least one machine learning model that is activated based on at least a first objective associated with a demeanor of at least a first participant of a network-based conversation (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various embodiments have been described above, it should be understood that they have been presented by way of example only, and not limitation. Thus, the breadth and scope of a preferred embodiment should not be limited by any of the above-described example embodiments, but should be defined only in accordance with the following claims and their equivalents.

What is claimed is:

1. A method comprising:
obtaining, by a processing system including at least one processor, at least a first objective associated with a demeanor of at least a first participant for a conversation;
activating, by the processing system, at least one machine learning model associated with the at least the first objective;
applying, by the processing system, a conversation content of the at least the first participant as at least a first input to the at least one machine learning model; and
performing, by the processing system, at least one action in accordance with an output of the at least one machine learning model.

2. The method of claim 1, wherein the conversation comprises at least one of:
a text-based conversation;
a speech-based conversation; or
a video-based conversation.

3. The method of claim 1, wherein the at least the first objective comprises:
an objective of the at least the first participant to align the conversation content of the at least the first participant with the demeanor of the first participant during the conversation.

4. The method of claim 3, wherein the applying further comprises applying at least a second input to the at least one machine learning model, wherein the at least the second input comprises at least one of:
biometric data of the at least the first participant; or
image data of the at least the first participant.

5. The method of claim 4, wherein the at least one machine learning model comprises at least two machine learning models, wherein the at least two machine learning models comprise at least:
a first demeanor detection model that is configured to detect a first demeanor from the at least the first input; and
a second demeanor detection model that is configured to detect a second demeanor from the at least the second input.

6. The method of claim 5, wherein the output of the at least one machine learning model comprises an indicator of a discrepancy between the first demeanor and the second demeanor.

7. The method of claim 6, wherein the at least one action comprises:
presenting the indicator to the at least the first participant of the discrepancy.

8. The method of claim 1, wherein the at least one action comprises:
altering the conversation content of the at least the first participant to align to a selected demeanor.

9. The method of claim 8, wherein the altering comprises:
applying the conversation content of the at least the first participant as an input to an encoder-decoder neural network, wherein an output of the encoder-decoder neural network comprises an altered conversation content of the at least the first participant.

10. The method of claim 9, wherein the conversation content of the at least the first participant comprises recorded speech, wherein the altering further comprises:
performing a speech-to-text conversion to obtain a generated text, wherein the generated text comprises the input to the encoder-decoder neural network; and
applying the altered conversation content of the at least the first participant to a text-to-speech module that is configured to output generated speech.

11. The method of claim 10, wherein the text-to-speech module is configured to output the generated speech that is representative of a voice of the at least the first participant.

12. The method of claim 9, wherein the at least one action further comprises:
presenting the altered conversation content of the at least the first participant to at least a second participant of the conversation.

13. The method of claim 9, wherein the altered conversation content is of a different language than the conversation content of the at least the first participant.

14. The method of claim 1, wherein the at least the first objective comprises an objective of the at least the first participant to convey a selected demeanor to at least a second participant.

15. The method of claim 14, wherein the at least one machine learning model comprises a demeanor detection model that is configured to detect at least a first demeanor from the at least the first input.

16. The method of claim 15, wherein the output of the at least one machine learning model comprises an indicator of a discrepancy between the at least the first demeanor and the selected demeanor.

17. The method of claim 16, wherein the at least one action comprises:
presenting the indicator of the discrepancy to the at least the first participant.

18. The method of claim 1, wherein the at least the first objective is at least one of:
obtained in accordance with at least one input of the at least the first participant; or
determined in accordance with one or more factors, wherein the one or more factors include:
a user profile of the at least the first participant;
a user profile of at least a second participant;
a relationship between the at least the first participant and the at least the second participant;
at least one communication modality of the conversation;
at least one location of at least one of: the at least the first participant or the at least the second participant; or
at least one topic of the conversation.

19. A non-transitory computer-readable medium storing instructions which, when executed by a processing system including at least one processor, cause the processing system to perform operations, the operations comprising:
obtaining at least a first objective associated with a demeanor of at least a first participant for a conversation;
activating at least one machine learning model associated with the at least the first objective;
applying a conversation content of the at least the first participant as at least a first input to the at least one machine learning model; and
performing at least one action in accordance with an output of the at least one machine learning model.

20. A device comprising:
a processing system including at least one processor; and
a computer-readable medium storing instructions which, when executed by the processing system, cause the processing system to perform operations, the operations comprising:
obtaining at least a first objective associated with a demeanor of at least a first participant for a conversation;
activating at least one machine learning model associated with the at least the first objective;
applying a conversation content of the at least the first participant as at least a first input to the at least one machine learning model; and
performing at least one action in accordance with an output of the at least one machine learning model.
